(19) United States
(12) Patent Application Publication
(10) Pub. No.: US 2008/0192755 A1
(43) Pub. Date: Aug. 14, 2008

(54) CONSTITUENT VIRTUAL CIRCUIT CONNECTION EVALUATION METHOD AND APPARATUS

(75) Inventors: Keven D. Gunwall, Crystal Lake, IL (US); Qing Liu, Hoffman Estates, IL (US); John J. Sojka, Lemont, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/673,841

(22) Filed: Feb. 12, 2007

(51) Int. Cl. H04L 12/56

(52) U.S. Cl. 370/397

(57) ABSTRACT

An aggregate virtual circuit multi-link frame relay-based platform can detect connection of at least one constituent virtual circuit to at least a second aggregate virtual circuit and then, prior to initiating ordinary use of that detected connection, automatically transmit, via each detected connection, an identifier to that second aggregate virtual circuit. The latter can then use that identifier to facilitate confirming that the detected connections represent a logical coupling that is at least substantially consistent with a physical coupling as between these two aggregate virtual circuits. This identifier can comprise, for example, an identifier for the aggregate virtual circuit itself or even, if desired, a globally unique identifier that uniquely and separately identifies each constituent virtual circuit. By one approach, when an aggregate virtual circuit determines that the logical coupling is not substantially consistent with the physical coupling, a predetermined action can be responsively taken.

### TECHNICAL FIELD

This invention relates generally to aggregate virtual circuit (AVC) multi-link frame relay-based platforms and more particularly to constituent virtual connections (CVCs) between such AVCs.

### BACKGROUND

Frame relays are known in the art and are typically deployed to facilitate intercouplings in communication systems using a frame relay protocol (which itself typically comprises a layer 2 protocol). Multi-link frame relays are also known in the art and often serve to combine multiple physical bearers (such as T1 or E1 lines) into one logical bundle. The physical interconnection between multi-link frame relays typically comprises a large number of bearers, such as electrically conductive or light carrying cables.

It is important that the physical connections between multi-link frame relays are accurately and correctly made. A misconnection typically causes the misconnected cable to become unavailable for useful traffic bearing purposes. The current art of multi-link frame relays is to have each end of the bearer service send a single identification packet to the far end service. The far end service uses this received identification packet to determine if it is connected to the correct far end service. The identification packet only traverses one of the physical bearer services. As a result of this single identification packet, a significantly likelihood exists in many applications settings that one or more physical connections between a given pair of multi-link frame relays is incorrect.

When such an installation error occurs, it can be difficult to locate the problem or even, in many instances, to confirm that the error even exists. In many cases, it can require the time and attention of relatively skilled service personnel to diagnose the existence of the problem and to effect its resolution. This, in turn, all tends to increase operating costs and/or reduce the throughput capability of a given communications network.

### BRIEF DESCRIPTION OF THE DRAWINGS

The above needs are at least partially met through provision of the CVC connection evaluation method and apparatus described in the following detailed description, particularly when studied in conjunction with the drawings, wherein:

FIG. 1 comprises a prior art block diagram;

FIG. 2 comprises a flow diagram as configured in accordance with various embodiments of the invention;

FIG. 3 comprises a flow diagram as configured in accordance with various embodiments of the invention; and

FIG. 4 comprises a block diagram as configured in accordance with various embodiments of the invention.

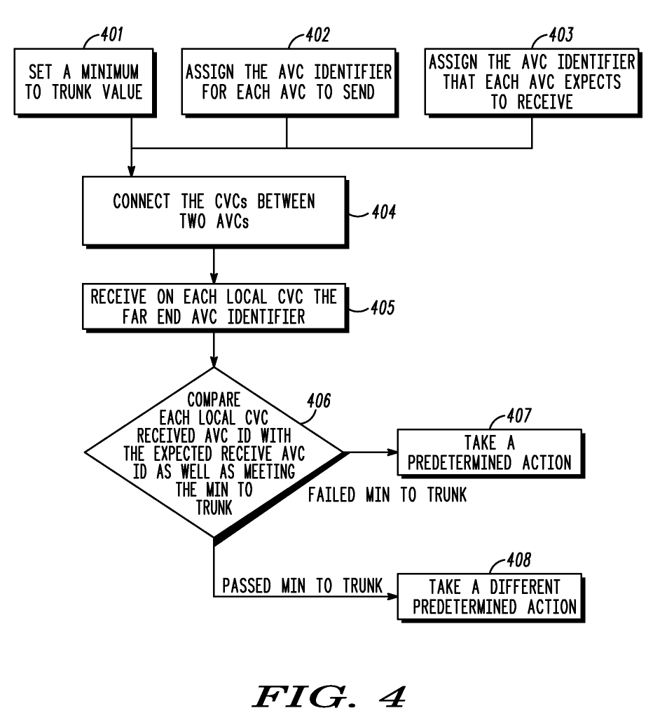

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, an AVC multi-link frame relay-based platform detects connection of at least one CVC to at least a second AVC and then, prior to initiating ordinary use of that detected connection, automatically transmit, via each detected connection, an identifier to that second AVC. The second AVC can then use that identifier to facilitate confirming that the detected connections represent a logical coupling that is at least substantially consistent with a physical coupling as between these two AVCs. This identifier can vary with respect to the needs and/or capabilities of a given application setting but can comprise, for example, an identifier for the AVC itself or even, if desired, a globally unique identifier that uniquely and separately identifies each CVC.

By one approach, when an AVC determines that the logical coupling is not substantially consistent with the physical coupling, a predetermined action can be responsively taken. This predetermined action can vary with respect to the needs and/or capabilities of a given application setting, such as sending an alarm (e.g., to a management station), displaying an error on the console, displaying a visual indication of the misconnection, or the like.

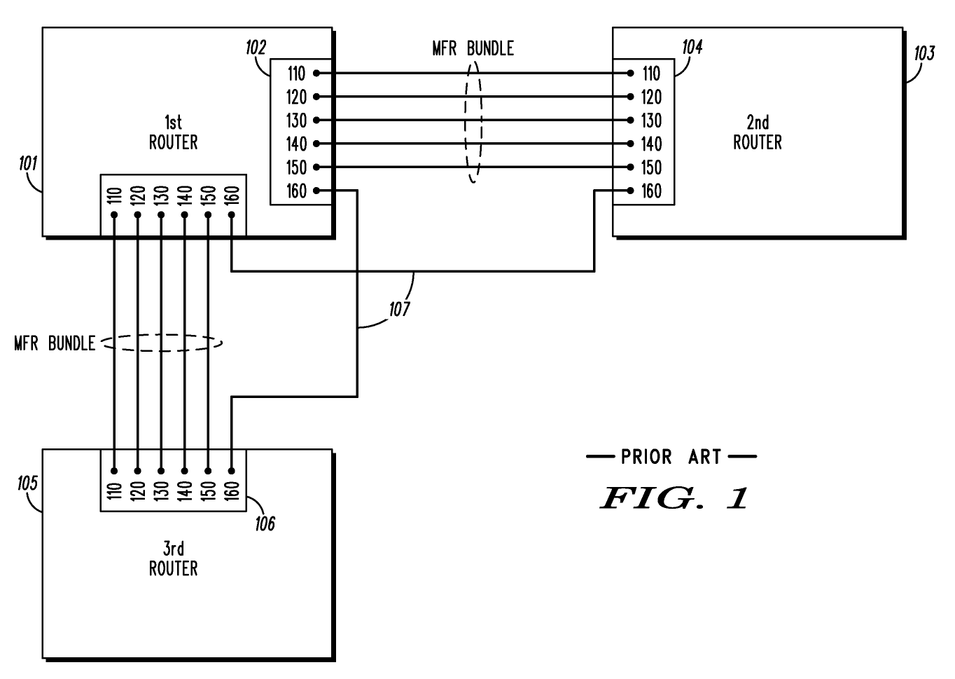

Prior to further elaboration, it may be helpful to first briefly present an example of a problem as presently characterized in the prior art. Referring now to FIG. 1, a first router 101 having a first AVC 102 connects to an AVC 104 of a second router 103. The first router 101 comprises a second AVC 107 that connects to an AVC 106 of a third router 105. In this illustrative example, two of the physical connections 108 are misconnected as shown.

Notwithstanding the presence of these misconnections, existing frame relay protocols typically facilitates detection of these connections. As existing frame relay protocols tend to have no native capability to detect such an error, the corresponding routers attempt to use these connections to route Internet Protocol packets. In the particular example shown, data packets sent via the misconnected physical connections 108 will of course be misdirected and eventually discarded. When discarded packets comprise multicast packets, it is possible for one or more of these routers to become overloaded with looped packets and eventually crash. At a minimum, it will be clear to those skilled in the art that such a misconnection typically leads to reduced throughput capability for the platforms involved.

The present teachings squarely address such a circumstance. In particular, these teachings provide for the automated detection of such a misconnection. Such detection can then be employed as desired by the relevant system designer and/or system administrator. By one approach, such a detection facilitates the provision of an alarm. In addition, or in lieu thereof, diagnostic content can be provided (such as identifying information regarding a location of the misconnection).

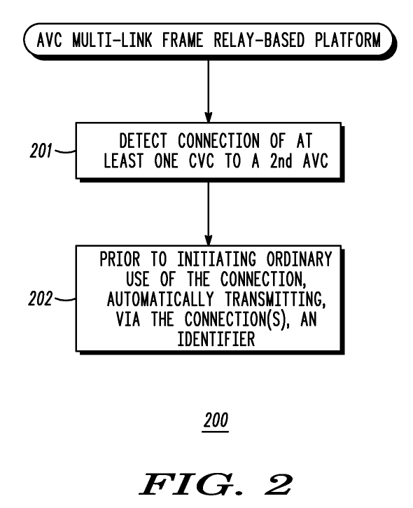

These and other benefits may become clearer upon making a thorough review and study of the following detailed description. Referring now to the drawings, and in particular to FIG. 2, a process 200 for use with an AVC multi-link relay-based platform provides for detecting 201 a connection of a first AVC to a second AVC via at least one CVC to thereby provide at least one detected connection. This process 200 then provides for automatically transmitting 202, via each detected connection, an identifier to the second AVC to thereby facilitate having the second AVC confirm that the detected connections represent a logical coupling between the first AVC and the second AVC is at least substantially consistent with a physical connection between the first AVC and the second AVC.

By one approach, this step of automatically transmitting 202 an identifier to the second AVC occurs prior to the AVC otherwise initiating ordinary use of the at least one detected connection. This can comprise, for example, taking this step prior to using the detected connection to convey or otherwise bear end user communications traffic.

As will be described in more detail, this identifier can comprise, if desired, an identifier that corresponds to the AVC itself or can, if desired, comprise a globally unique identifier that uniquely identifies each CVC separately. AVCs typically have at least one unique identifier (where those skilled in the art will understand that “unique” in this context typically connotes the notion that the identifier is at least unique within a given communication system or network) that can be used for the former approach. In some cases, the identifiers as may already be provided for CVCs may be adequate to facilitate the latter approach, but in many cases, the relatively few number of identifiers as are presently accommodated by the prior art in this regard are too few to ensure global uniqueness (where “global” will be understood to encompass a given communication system or network). In that case, a system administrator may pre-assign and pre-provision globally unique identifiers for each CVC within a given network to ensure the availability of such information in support of these teachings. An eight-bit identifier, for example, is sufficient to meet essentially all likely present day needs in this regard.

By one approach, when a first AVC and a second AVC are coupled to one another, each affects the above-described process 200. This, in turn, ensures in providing both AVCs with identifying information that can be employed to make the described determination regarding the detected connections.

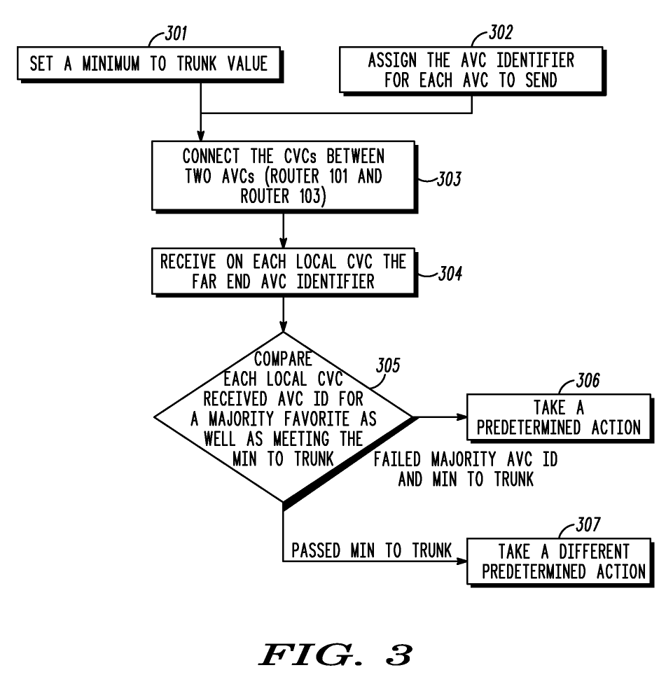

Referring now to FIG. 3, and presuming provision of identifying information via the above-described process 200 or via any other mode that may be appropriate and/or available in a given application setting, a corollary process 300 is again suitably executed by an AVC multi-link frame relay-based platform. This process 300 can optionally begin, if desired, with setting 301 a minimum-to-trunk value as well as an AVC identifier for each router 101, 103 and 105. This AVC identifier must be unique to each receiving router, which means that router 103 and 105 must not share an AVC identifier.

This process 300 specifically provides for receiving 304, via each CVC that connects the receiving AVC to a second AVC, an identifier as described above. In the case where these identifiers comprise, for example, an AVC identifier, this process 300 can next provide for using the received identifiers to determine 305 whether the logical coupling between the receiving AVC and the second AVC is at least substantially consistent with the physical connection between these two network elements and that the set value 301 of minimum-to-trunk has been met. An appropriate predetermined action can then be automatically taken 306.

The precise nature of this predetermined action can and will likely vary from one application setting to another. One example would be to inhibit normal operation of the AVC with respect to those CVC connections (notwithstanding, for example, earlier confirmation that a minimum-to-trunk value existed).

There are various ways by which this determination 305 can be carried out. By one approach, the receiving AVC can determine whether all of the received identifiers correlate to a common AVC. To provide a simple illustrative example, an AVC having an AVC identifier “123” can cause that identifier to be transmitted via each of 8 CVCs as coupled to a receiving AVC. The receiving AVC can then compare the received AVC identifiers from each CVC against each other to confirm that each CVC presents the same AVC identifier. This result, in turn, can form the basis of determining that all of the CVCs are physically and logically connected in a substantially (in fact, “exactly” in this illustrative example) consistent manner.

In the above example, all of the CVCs are properly connected. In many application settings this will comprise a requirement; anything less than a full set of completely correctly connected CVCs may be unacceptable. In some cases, however, a system administrator may have reason to be more forgiving, hence the minimum-to-trunk value 301. For example, it may be more important at some moment in time to be able to provide at least some connectivity rather than ensuring that the system is operating at full potential. In such a case, if desired, something less than full compliance may be permitted. To facilitate that approach, this determination can comprise determining whether the physical and logical connections are at least substantially consistent with respect to a measure that is less than fully compliant.

To illustrate, a system administrator may be willing to accept one mis-connection, but not more than one such misconnection. In such a case, and presuming only one misconnection in an example such as that presented above, consider an example where the minimum-to-trunk value of seven has been set, and seven CVCs present an identical AVC identifier while the eighth CVC presents a different identifier that corresponds to the misconnected AVC that sources that different identifier. In this example, since seven CVCs present a common identifier, this process 300 can again determine that at least substantial consistency exists when comparing the physical connections with the logical couplings. In a case where two or more misconnections exist, however, this determination can conclude instead that substantially consistency is absent.

As another illustrative example, a simple majority determination can serve as a test regarding whether the logical coupling between these AVCs is at least substantially consistent with the physical connection. For example, if there are a total of eight CVCs, and five of them present the correct identifier, this determination 304 can be positive based upon the observation that a majority of the CVCs meet the prescribed requirement.

When different identifiers arrive at the receiving AVC when using a shared identifier for all CVCs that share a common AVC, it can become important to determine which identifier is, in fact, the identifier for the correct AVC. For example, six CVCs might present the AVC identifier “123” while two CVCs present the AVC identifier “456.” In such a case, if desired, this process 300 can be configured to presume that whichever identifier represents a majority of the received identifiers comprises the correct AVC. In this particular example, this process 300 would then conclude that the AVC identifier “123” comprises the correct identifier. The process 300 could then continue as described above. For example, in this example, two of the CVCs are not correctly connected (presuming that AVC identifier “123” is the correct identifier) and this value may then be used to determine whether the logical coupling between these AVCs is at least substantially consistent with the physical connection.

When the above described step regarding determining 305 whether substantially consistency exists with respect to logical and physical couplings is affirmative, this process 300 will then readily support automatically taking 307 a predetermined action that is different than the aforementioned predetermined action 306. By one approach, for example, this might comprise simply proceeding in an ordinary manner as might otherwise occur in the application setting of choice. If desired, this predetermined action can comprise, in whole or in part, confirming that the physical connection between the two AVCs is suitable for use.

As noted above, in some cases (as when the identifier comprises an AVC identifier) it may be appropriate to use a majority-based criterion to identify the correct AVC identifier as between two or more candidate identifiers being provided via a given set of CVC connections. In such a case, it is possible that the majority-based result will be incorrect. This could occur, for example, when a majority of the CVCs are incorrectly connected. Though hopefully a relatively rare or unlikely occurrence, such a scenario could result in an attempt to instigate ordinary service under circumstances likely to result in substandard service.

If the above condition is not an optimal outcome, then process 400 can further optionally provide expected received behavior, which can allow added logic to the decision 406 in determining an adequate number of CVCs are present with the appropriate AVC identifier.

As an example, a minimum-to-trunk value 401 has been set to 5 CVCs, while the AVC identifier has been set to 102, and the AVC receive identifier has been set to 104. Eight CVCs are connected to this router 101, comprising of three CVCs from AVC 104 and five CVCs from AVC 106. In this case, the expected AVC receive identifier is 104 with a minimum-to-trunk of five CVCs, but only three CVCs identify they received AVC identifier 104, so the predetermined action 407 would take place.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at an aggregate virtual circuit (AVC) multi-link frame relay-based platform:
receiving, via each constituent virtual circuit (CVC) that connects the AVC to a second AVC, an identifier to provide corresponding received identifiers for each CVC;
comparing the received identifiers to determine whether logical coupling between the AVC and the second AVC is at least substantially consistent with a physical connection between the AVC and the second AVC; and
upon determining that the logical coupling is not at least substantially consistent with the physical connection, automatically taking a predetermined action.

2. The method of claim 1 wherein the corresponding identifier comprises an AVC identifier.

3. The method of claim 1 wherein using the received identifier to determine whether the logical coupling between the AVC and the second AVC is at least substantially consistent with a physical connection between the AVC and the second AVC comprises, at least in part, determining whether all of the received identifiers correlate to a common AVC.

4. The method of claim 3 wherein determining whether all of the received identifiers correlate to a common AVC further comprises determining whether at least a majority of the received identifiers correlate to the second AVC.

5. The method of claim 4 wherein, upon determining that the logical coupling is not at least substantially consistent with the physical connection, automatically taking a predetermined action further comprises, upon determining that less than a majority of the received identifiers correlate to the second AVC, automatically taking a predetermined action.

6. The method of claim 1 further comprising a preceding step of confirming that a minimum-to-trunk value has been at least met.

7. The method of claim 1 further comprising:
upon determining that the logical coupling is at least substantially consistent with the physical connection, automatically taking a different predetermined action.

8. The method of claim 7 wherein automatically taking a different predetermined action comprises confirming that the physical connection between the AVC and the second AVC is suitable for use.

9. The method of claim 7 wherein, upon determining that the logical coupling is at least substantially consistent with the physical connection, automatically taking a different predetermined action further comprises, upon determining that at least a majority of the received identifiers correlate to the second AVC, automatically taking the different predetermined action.

10. The method of claim 9 further comprising:
subsequent to automatically taking the different predetermined action, monitoring communications between the AVC and the second AVC; and
upon detecting a first predetermined condition with respect to the communications between the AVC and the second AVC, now determining that less than a majority of the received identifiers correlate to the second AVC.

11. The method of claim 1 wherein the corresponding identifier comprises a globally unique identifier.

12. The method of claim 11 further comprising providing information that correlates each CVC connector for the AVC with each globally unique identifier for each CVC as corresponds to the second AVC:
and wherein using the received identifiers to determine whether logical coupling between the AVC and the second AVC is at least substantially consistent with a physical connection between the AVC and the second AVC further comprises comparing the information that correlates each CVC connector for the AVC with each globally unique identifier for each CVC with the received identifiers.

13. A method comprising:
at an aggregate virtual circuit (AVC) multi-link frame relay-based platform:
detecting connection of at least one constituent virtual circuit (CVC) to a second AVC to provide at least one detected connection; and
prior to initiating ordinary use of the at least one detected connection, automatically transmitting, via each detected connection, an identifier to the second AVC to thereby facilitate having the second AVC confirm that the detected connections represent a logical coupling between the AVC and the second AVC that is at least substantially consistent with a physical connection between the AVC and the second AVC.

14. The method of claim 13 wherein the identifier comprises an identifier for the AVC.

15. The method of claim 13 wherein the identifier comprises a globally unique identifier that uniquely separately identifies each CVC.

16. The method of claim 13 further comprises:
receiving from the second AVC, via each detected connection, a received identifier for each CVC;
using the received identifiers to determine whether the logical coupling between the AVC and the second AVC is at least substantially consistent with the physical connection between the AVC and the second AVC; and
upon determining that the logical coupling is not at least substantially consistent with the physical connection, automatically taking a predetermined action.

17. An aggregate virtual circuit (AVC) multi-link frame relay-based platform comprising:
a plurality of constituent virtual circuit (CVC) physical interfaces to permit CVC connections to a second AVC;
a memory having stored therein received identifiers for each connected CVC that has been received via each CVC that connects the AVC to the second AVC; and
a processor operably coupled to the memory and being configured and arranged to:
use the received identifiers to determine whether logical coupling between the AVC and the second AVC is at least substantially consistent with a physical connection between the AVC and the second AVC;
automatically take a predetermined action when the logical coupling is not at least substantially consistent with the physical connection.

18. The AVC multi-link frame relay-based platform of claim 17 wherein the received identifiers are at least one of:
an AVC identifier; or
a globally unique CVC identifier.

19. The AVC multi-link frame relay-based platform of claim 17 further comprising:
a CVC connection detector that is operably coupled to the plurality of CVC physical interfaces; and
a second memory having stored therein at least one local identifier, wherein the processor is further operably coupled to the second memory and the CVC connection detector and is further configured and arranged to facilitate the automatic transmission, prior to initiation of ordinary use of a detected connection, of the at least one local identifier via each detected connection to thereby facilitate having the second AVC confirm that the detected connections represent a logical coupling between the AVC and the second AVC that is at least substantially consistent with a physical connection between the AVC and the second AVC.
